(19) United States
(12) Patent Application Publication
(10) Pub. No.: US 2006/0221612 A1
(43) Pub. Date: Oct. 5, 2006

(54) Backlight unit and liquid crystal display having the same

(75) Inventors: Chun-ho Song, Seoul City (KR); Gi-cherl Kim, Yongin-si (KR); Se-ki Park, Suwon-si (KR); Byung-choon Yang, Seongnam-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/378,560

(22) Filed: Mar. 17, 2006

(30) Foreign Application Priority Data
Mar. 29, 2005 (KR) 2005-25928

(51) Int. Cl. F21V 7/00

(52) U.S. Cl. 362/247; 362/297; 362/346

(57) ABSTRACT

A backlight unit comprises a light source part, and a reflective partition for dividing the light source part into a plurality of areas and reflecting light from the light source part. The light source part comprises a light emitting diode and a circuit board on which the light emitting diode is disposed. The reflective partition has a greater height than the light emitting diode.

### CROSS-REFERENCE TO RELATED APPLICATION

This application claims priority to Korean Patent Application No. 2005-0025928, filed on Mar. 29, 2005, the disclosure of which is incorporated herein by reference.

### BACKGROUND OF THE INVENTION

1. Technical Field

The present disclosure relates to a backlight unit and a liquid crystal display (LCD) having the same, and more particularly to a backlight unit and an LCD with a reduced thickness.

2. Discussion of the Related Art

A conventional display such as a cathode ray tube (CRT) has been replaced with, for example, a liquid crystal display (LCD), a plasma display panel (PDP), and an organic light emitting diode (OLED) display.

The LCD comprises a liquid crystal panel having a TFT substrate, a color filter substrate and a liquid crystal layer disposed therebetween. The liquid crystal panel does not emit light by itself. Therefore, a backlight unit is disposed behind the TFT substrate for providing light. The transmittance of the light from the backlight unit depends on an alignment of liquid crystal molecules within the liquid crystal panel. The liquid crystal panel and the backlight unit are enclosed within a chassis.

The backlight unit is classified as an edge type and a direct type based on a location of a light source in the backlight unit.

The edge type backlight unit has its light source placed at a side of a light guide plate, and is used for a small size LCD such as a laptop or a desktop computer monitor. Such an edge type backlight unit is suitable for a thin LCD since the edge type backlight unit has high light uniformity and a long life span.

The direct type backlight unit can be used for a larger size LCD, and provides the entire liquid crystal panel with light by light sources disposed behind the liquid crystal panel. Since the direct type backlight unit comprises more light sources than the edge type backlight unit, the direct type backlight unit may have a higher brightness than the edge type backlight unit. However, the brightness of the direct type backlight unit may not be uniform.

A light emitting diode (LED) having high brightness and color reproducibility, can be used for the light source of the backlight unit. The backlight unit, using the LED for its light source, includes a plurality of LEDs for emitting red, green, or blue colors. The LCD needs enough space for mixing the lights from each LED to produce white light. A gap between the LED and the liquid crystal panel for securing such space hinders reducing the thickness of the LCD.

### SUMMARY OF THE INVENTION

Embodiments of the present invention provide a backlight unit and an LCD with a reduced thickness.

According to an embodiment of the present invention, a backlight unit comprises a light source part and a reflective partition dividing the light source part into a plurality of areas and reflecting light from the light source part.

The light source part may comprise an LED and an LED circuit board on which the LED is disposed, and the reflective partition has a greater height than the LED.

The LED may comprise an LED chip and a bulb encompassing the LED chip, and the reflective partition has a greater height than the LED chip.

The reflective partition may comprise a white film.

The reflective partition may comprise polyethylene terephthalate or polycarbonate.

A surface of the reflective partition is not a mirror-type.

The surface of the reflective partition may be embossed with protrusions.

The area may include an approximately rectangular shape.

According to an embodiment of the present invention, an LCD comprises a liquid crystal panel a light source part disposed behind the liquid crystal panel and divided into a plurality of areas and a reflective partition partitioning the plurality of areas and reflecting light from the light source part.

The light source part may comprise an LED and an LED circuit board on which the LED is disposed, and the reflective partition has a greater height than the LED.

The LED may comprise an LED chip and a bulb encompassing the LED chip, and the reflective partition has a greater height than the LED chip.

The LCD may further comprise a light regulating part disposed between the reflective partition and the liquid crystal panel, wherein the reflective partition and the light regulating part may not contact with each other.

The light source part may be disposed across the entire rear portion of the liquid crystal panel.

The reflective partition may comprise a white film.

The reflective partition may comprise polyethylene terephthalate or polycarbonate.

A surface of the reflective partition is not a mirror-type.

The surface of the reflective partition may be embossed with protrusions.

The area includes an approximately rectangular shape.

According to an embodiment of the present invention, an LCD comprises a liquid crystal panel a reflective partition disposed behind the liquid crystal panel and defining a plurality of areas and an LED light source part having LEDs disposed in each of the plurality of areas.

### BRIEF DESCRIPTION OF THE DRAWINGS

Preferred embodiments of the present disclosure can be understood in more detail from the following description taken in conjunction with the accompanying drawings in which:

FIG. 1 is an exploded perspective view of an LCD according to an embodiment of the present invention;

FIG. 2 is a sectional view of an LCD according to an embodiment of the present invention;

FIG. 3 is a perspective view of a part of a backlight unit of an LCD according to an embodiment of the present invention;

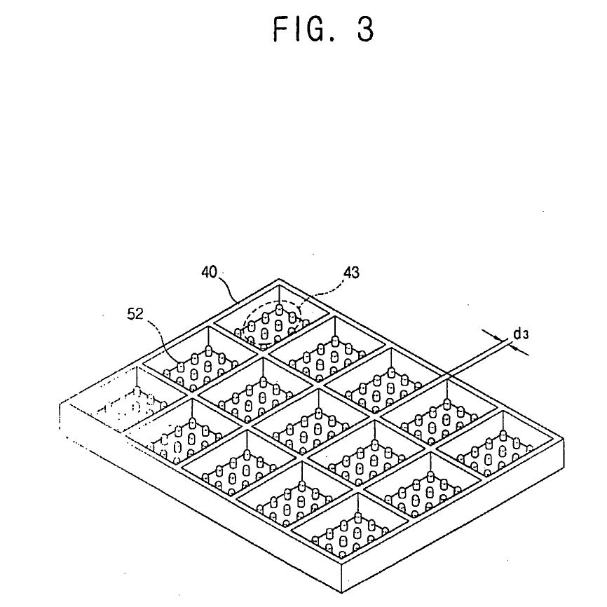

FIG. 4 illustrates a path of light in an LCD according to an embodiment of the present invention;

FIG. 5 is a perspective view of a part of a backlight unit of an LCD according to another embodiment of the present invention; and

FIG. 6 is a perspective view of a part of a backlight unit of an LCD according to another embodiment of the present invention.

### DETAILED DESCRIPTION OF THE PREFERRED EMBODIMENTS

Preferred embodiments of the present invention will be described below in more detail with reference to the accompanying drawings. The present invention may be embodied in many different forms and should not be construed as limited to the embodiments set forth herein.

A liquid crystal display (LCD) 1 comprises a liquid crystal panel 20 and a backlight unit 80. The backlight unit 80 comprises a light regulating part 30 disposed behind the liquid crystal panel 20, a reflective partition 40 disposed behind the light regulating part 30 and an LED light source part 50.

The liquid crystal panel 20 comprises a TFT substrate 21 on which TFTs are formed, a color filter substrate 22 facing the TFT substrate 21, a sealant 23 joining the two substrates 21 and 22 and forming a cell gap, and a liquid crystal layer 24 enclosed by the two substrates 21 and 22 and the sealant 23. The liquid crystal panel 20 controls an alignment of the liquid crystal molecules in the liquid crystal layer 24, thereby forming an image. Since the liquid crystal panel 20 does not emit light by itself, light is received from the LED light source part 50 disposed behind the liquid crystal panel 20.

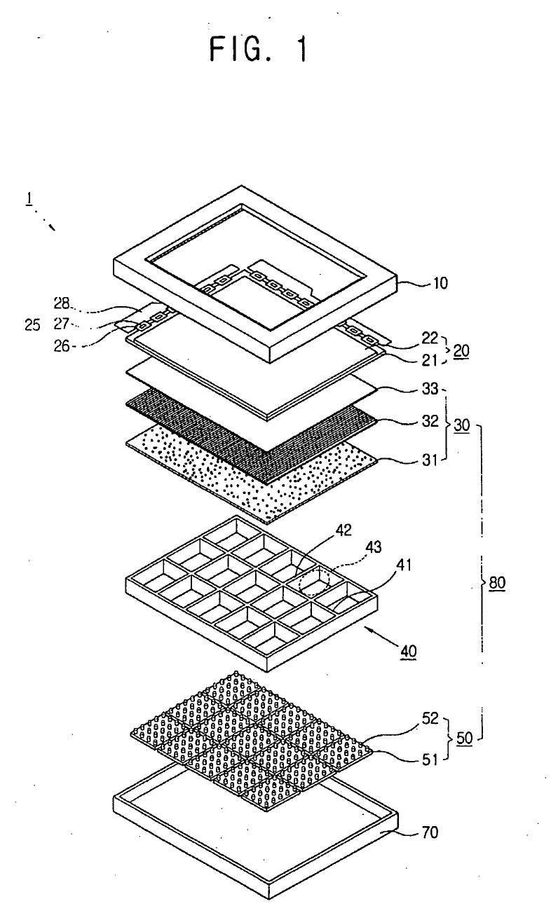

On a side of the TFT substrate 21 is provided a driving part 25 supplying driving signals. The driving part 25 comprises a flexible printed circuit (FPC) 26, a driving chip 27 disposed on the flexible printed circuit 26, and a printed circuit board (PCB) 28 connected to a side of each of the flexible printed circuits 26. The driving part 25 shown in FIG. 1 is formed in a chip on film (COF) type substrate. Alternatively, a known technology such as, for example, tape carrier package (TCP) or chip on glass (COG) can be used. The driving part 25 can be formed on the TFT substrate 21 while wirings are formed.

The light regulating part 30 disposed behind the liquid crystal panel 20 may comprise a diffuser plate 31, a prism film 32 and a protection film 33.

The diffuser plate 31 comprises a base plate and a coating layer. The diffuser plate 31 includes beads formed on the base plate. Since the LED light source part 50 is a point light source, an arrangement of LEDs 52 may be visible from the exterior of an LCD apparatus, and light uniformity can be lowered.

The diffuser plate 31 diffuses light received from the LED light source part 50, thereby making the brightness uniform. On a region of the diffuser plate 31 where the light received from the LED 52 is most concentrated may be formed a light block pattern comprising a substance having a low transmittance so that the arrangement of the LEDs 52 is not visible. A light guide plate and a diffuser film may be used instead of the diffuser plate 31.

A triangular prism is placed on the prism film 32 in a predetermined arrangement. The prism film 32 concentrates light diffused from the diffuser plate 31 in a direction perpendicular to a surface of the liquid crystal panel 20. In an embodiment of the present invention, two prism films 32 are used, and micro prisms formed on the prism films 32 form predetermined angles with respect to the prism films. The light passing through the prism film 32 progresses vertically, thereby forming a uniform brightness distribution. In an embodiment of the present invention, a reflective polarizing film may be used along with the prism film 32. Alternatively, only the reflective polarizing film may be used without the prism film 32.

The protection film 33, placed on top of the light regulating part 30, protects the prism film 32 from scratches.

The size of the reflective partition 40 is substantially similar to the size of the liquid crystal panel 20. The reflective portion 40 has an approximately rectangular shape. The reflective partition 40 comprises transverse partitions 41 parallel with one another and longitudinal partitions 42 perpendicular to the transverse partitions 41. The transverse partition 41 intersects the longitudinal partition 42, thereby defining a plurality of enclosed areas 43. Each enclosed area 43 is formed in an approximately rectangular shape. The size of each enclosed area 43 is the same.

In an embodiment of the present invention, there are fifteen enclosed areas 43, formed with five rows in an extension direction of the transverse partition 41 and three columns in an extension direction of the longitudinal partition 42. The reflective partition 40, including the transverse and longitudinal portions 41, 42, has a greater height than the LEDs 52. The reflective partition 40 reflects or diffuse-reflects the light received from the LEDs 52. The reflective partition 40 may comprise, for example, a white film, and polyethylene terephthalate (PET), polycarbonate (PC), or foamed polyethylene terephthalate.

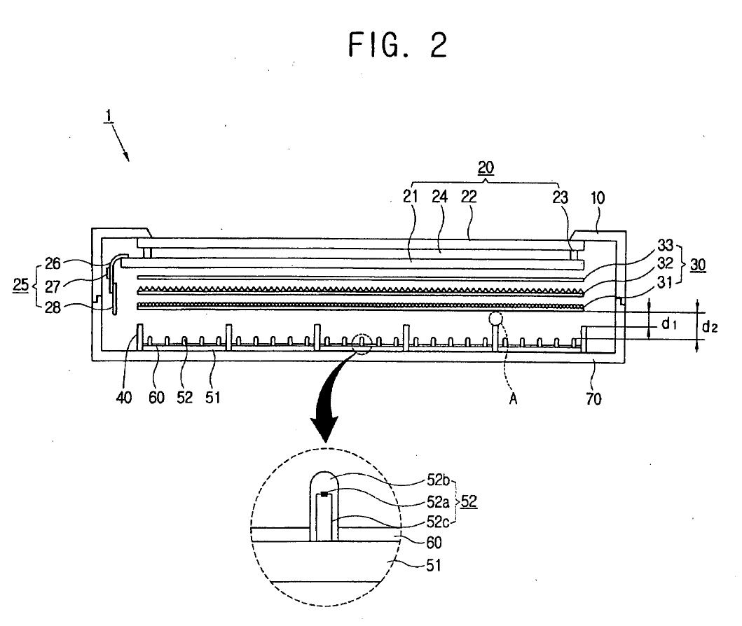

The reflective partition 40 may appear as a dark line on the LCD. Accordingly, the surface of the reflective partition 40 is not a mirror-type surface so that the light received from the LED 52 is not specular-reflected but diffuse-reflected on the reflective partition 40. The reflective partition 40 is spaced apart from the diffuser plate 31 at a predetermined distance d1. That is, the reflective partition 40 does not contact the diffuser plate 31. A supporter (not shown) keeps the diffuser plate 31 from moving toward the reflective partition 40. Referring to FIG. 2, the light from the LED 52 is supplied to a space A between the reflective partition 40 and the diffuser plate 31, thereby preventing regions of the reflecting partition 40 from being lowered in brightness. Further, the thickness d3 of the reflective partition 40 is preferably thin so that the reflective partition 40 dose not appear as a dark line.

The LED light source part 50 comprises an LED circuit board 51 and the LED 52 disposed on the LED circuit board 51.

A plurality of the LED circuit boards 51 are disposed to correspond to each respective enclosed area 43 defined in the reflective partition 40. That is, one LED circuit board 51 is disposed in one enclosed area 43.

The LEDs 52, disposed on the LED circuit board 51, are disposed across the entire rear portion of the liquid crystal panel 20. The LED 52 comprises an LED chip 52a emitting light, a bulb 52b enclosing the LED chip 52a and diffusing the light and a lead 52c connecting the LED chip 52a and the LED circuit board 51. The bulb 52b may comprise epoxy resin. In each enclosed area 43 are disposed a plurality of LEDs 52. One enclosed area 43 preferably includes the LEDs 52 respectively red, green and blue color.

In an embodiment of the present invention, the reflective partition 40 is formed as a single body but the LED circuit board 51 is not formed as a single body. Alternatively, the reflective partition 40 may be separately disposed at each and every enclosed area 43, and the LED circuit board 51 may be formed as a single body across the entire rear portion of the liquid crystal panel 20.

On a region of the LED circuit board 51 where the LED 52 is not disposed is provided a reflective plate 60. The reflective plate 60 reflects the light delivered downward to the diffuser plate 31. The reflective plate 60, like the reflective partition 40, may comprise, for example, polyethylene terephthalate (PET) or polycarbonate (PC). The reflective plate 60 is formed thick enough not to shrink due to heat generated from the LED 52.

The liquid crystal panel 20, light regulating part 30, reflective partition 40 and LED light source part 50 are accommodated by an upper chassis 10 and a lower chassis 70. The upper chassis 10 may be joined with the lower chassis 70 by a joining member such as, for example, a screw.

Although a distance d2 between the LED 52 and the diffuser plate 31 may be shorter than a distance between an LED and diffusion plate in a conventional LCD, the arrangement of the LED 52 is not visible from the outside.

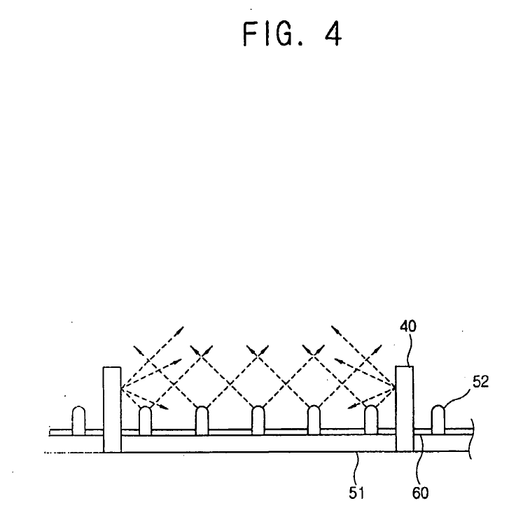

Referring to FIG. 4, on the LED circuit board 51 are disposed in turn the LEDs 52 each emitting red, green or blue colors. The light from the LED 52 progresses in a front direction. With this characteristic, the white color light is formed away from the LED 52 but at a spot spaced a certain distance from the LED 52. The diffuser plate 31 is located at a position where the certain distance is taken into consideration. Accordingly, as the spot where the white color light is formed becomes closer to the LED 52, the diffuser plate 31 can be located closer to the LED 52, thereby reducing the thickness of the LCD.

In an embodiment of the present invention, the LED 52 is enclosed by the reflective partition 40. The reflective partition 40 is formed to be taller than the LED 52. As shown in FIG. 4, the light from the LED 52 adjacent to the reflective partition 40 is reflected by the reflective partition 40, and mixed with the light from the adjacent LEDs 52. Since the reflective partition 40 diffuse-reflects incident light, the light rays from the LEDs 52 are mixed at a spot closer to the LEDs 52. Accordingly, the spot where the white light is formed becomes closer to the LEDs 52, resulting in a reduction of the distance between the diffuser plate 31 and the LEDs 52. Although the reflecting partition 40 is taller than the LEDs 52 in the embodiment, the reflecting partition 40 may be taller than the LED chips 52a but shorter than the bulbs 52b.

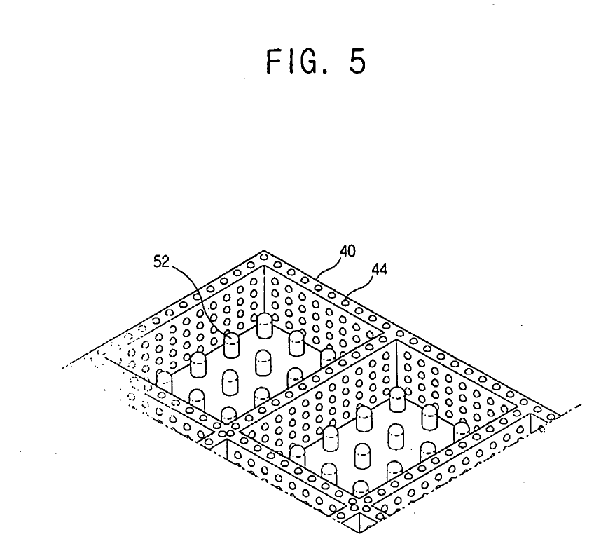

Another embodiment of the present invention will be described with reference to FIG. 5.

According to this embodiment of the present invention, a reflective partition 40 of an LCD is embossed with protrusions 44. Using these protrusions 44, the reflective partition 40 diffuses incident light. Accordingly, the light is supplied to a space between the reflective partition 40 and a diffuser plate 31 does not cause the reflecting partition 40 to be visible from the outside.

In an embodiment of the present invention, a light diffusing pattern may be printed on the reflective partition 40 or the reflective partition 40 may be curved to keep the reflecting partition 40 from being visible from the outside.

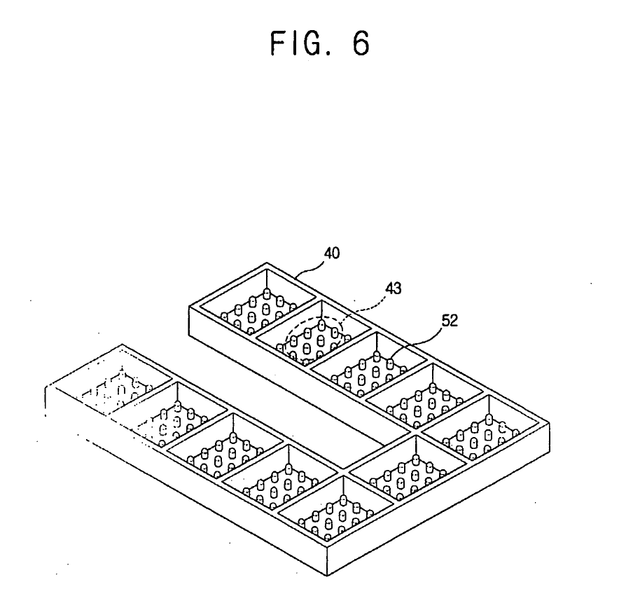

Another embodiment of the present invention will be described with reference to FIG. 6. According to this embodiment of the present invention, LEDs 52 are partially disposed behind a liquid crystal panel 20. The LEDs 52 are disposed, for example, in a ‘U’ shape, and LED circuit board 51 and reflective partition 40 are disposed to correspond to the “U” shaped arrangement of the LEDs 52.

Although the LEDs 52 are used for the light source in the above embodiments, they can be replaced with, for example, a cold cathode fluorescent lamp (CCFL) or an external electrode fluorescent lamp (EEFL).

Although preferred embodiments have been described herein with reference to the accompanying drawings, it is to be understood that the present invention is not limited to these precise embodiments but various changes and modifications can be made by one skilled in the art without departing from the spirit and scope of the present invention. All such changes and modifications are intended to be included with the scope of the invention as defined by the appended claims.

What is claimed is:

1. A backlight unit comprising:
a light source part; and
a reflective partition dividing the light source part into a plurality of areas and reflecting light from the light source part.

2. The backlight unit of claim 1, wherein the light source part comprises a light emitting diode and a circuit board on which the light emitting diode is disposed, and the reflective partition has a great height than the light emitting diode.

3. The backlight unit of claim 2, wherein the light emitting diode comprises a chip and a bulb enclosing the chip, and the reflective partition has a greater height than the chip.

4. The backlight unit of claim 1, wherein the reflective partition comprises a white film.

5. The backlight unit of claim 1, wherein the reflective partition comprises polyethylene terephthalate or polycarbonate.

6. The backlight unit of claim 1, wherein a surface of the reflective partition is a surface other than a mirror-type surface.

7. The backlight unit of claim 1, wherein a surface of the reflective partition is embossed with protrusions.

8. The backlight unit of claim 1, wherein each of the plurality of areas has an approximately rectangular shape.

9. A liquid crystal display comprising:
a liquid crystal panel;
a light source part disposed behind the liquid crystal panel and divided into a plurality of areas; and
a reflective partition partitioning the plurality of areas and reflecting light from the light source part.

10. The liquid crystal display of claim 9, wherein the light source part comprises a light emitting diode and a circuit board on which the light emitting diode is disposed, and the reflective partition has a greater height than the light emitting diode.

11. The liquid crystal display of claim 10, wherein the light emitting diode comprises a chip and a bulb enclosing the chip, and the reflective partition has a greater height than the chip.

12. The liquid crystal display of claim 9, further comprising a light regulating part disposed between the reflective partition and the liquid crystal panel, wherein the reflective partition and the light regulating part are not in contact with each other.

13. The liquid crystal display of claim 9, wherein the light source part is disposed across an entire rear portion of the liquid crystal panel.

14. The liquid crystal display of claim 9, wherein the reflective partition comprises a white film.

15. The liquid crystal display of claim 9, wherein the reflective partition comprises polyethylene terephthalate or polycarbonate.

16. The liquid crystal display of claim 9, wherein a surface of the reflective partition is a surface other than a mirror-type surface.

17. The liquid crystal display of claim 9, wherein the surface of the reflective partition is embossed with protrusions.

18. The liquid crystal display of claim 9, wherein each of the plurality of areas has an approximately rectangular shape.

19. A liquid crystal display comprising:
a liquid crystal panel;
a reflective partition disposed behind the liquid crystal panel and defining a plurality of areas; and
a light emitting diode light source part including LEDs disposed in each of the plurality of areas.
